(19) United States
(12) Patent Application Publication
(10) Pub. No.: US 2013/0013955 A1
(43) Pub. Date: Jan. 10, 2013

(54) METHOD AND SYSTEM FOR EMERGENCY SWITCHING

(76) Inventors: Guocai Wang, Shenzhen (CN); Xingxin Xia, Shenzhen (CN); Haojun Zhang, Shenzhen (CN)

(21) Appl. No.: 13/517,390

(22) PCT Filed: Sep. 16, 2010
(86) PCT No.: PCT/CN2010/076986

§ 371 Date: Jun. 20, 2012

(30) Foreign Application Priority Data
Apr. 2, 2010 (CN) 201010142717.1

(51) Int. Cl. G06F 11/07

(52) U.S. Cl. 714/4.2; 714/E11.023

(57) ABSTRACT

The disclosure relates to communication technologies and discloses a method and a system for emergency switching. In accordance with the embodiments of the present invention, by configuring a mapped IP address in a previous level network device which can map addresses, the embodiments of the present invention enable corresponding devices in respective service processing subsystems to be backup devices to each other. When a problem occurs in a device of a service processing subsystem, as long as an IP address, which is mapped to the network device, in the previous level network device is mapped to a corresponding device of another service processing subsystem, and the corresponding device in another service processing subsystem acts as a backup device to process a service of the device in which the problem occurs, thus enabling simple and fast starting of a backup device when a problem occurs in the original device.

### FIELD

The disclosure relates to communication technologies, and in particular to a method and a system for emergency switching in communication technologies.

### BACKGROUND

At present, multiple service processing subsystems exist in many communication systems. Each service processing subsystem is relatively independent. For example, a multimedia message service interworking gateway (MMSIG) service processing subsystem is used in a service forwarding system of a point-to-point MMS message among (or between) networks of operators, and an interworking gateway service processing subsystem is provided between each operator and any other operator, as a result, each operator at least has two sets of interworking gateway service processing subsystems.

As each service processing subsystem plays a significant role in communication process, significant devices are generally backed up for the purpose of avoiding a fault of a device of a service processing subsystem. At present, the generally adopted backup technology is a dual hot standby technology.

However, the dual hot standby technology has disadvantages as follows: 1) when a frame of a server cannot work due to a certain reason, such as power failure, the original device and the backup device which are in power failure due to the power failure of the frame cannot work, therefore switching cannot be realized in time; 2) when the switching is failed, the normal operation of the service still cannot be guaranteed. If the two cases occur, the backup device needs to be started manually to bear the service which the device in problem bears. Generally speaking, the time taken for starting the backup device manually is at least 1 to 2 hours, and the manual switching process is wasted in time and labour as well as goes wrong easily.

### SUMMARY

Considering the above, the embodiment of the present invention mainly provides a method and a system for emergency switching so as to start a backup device conveniently and rapidly when a problem occurs in an original device.

In order to solve the above technical problems, the technical solution of the embodiment of the present invention is realized in the following way.

A method for emergency switching comprises: after a problem occurs in a device of a first service processing subsystem, modifying, by a network device responsible for address mapping, a mapping relationship of an Internet Protocol (IP) address which is mapped to the first service processing subsystem so as to map the IP address which is mapped to the first service processing subsystem to a second service processing subsystem; and processing a service of the first service processing subsystem by the second service processing subsystem, wherein the second service processing subsystem stores data needed for processing the service of the first service processing subsystem in advance.

The step of processing the service of the first service processing subsystem by the second service processing subsystem comprises the following steps performed by the second service processing subsystem: starting using a first emergency account which is preset to be used to connect with a communication object of the first service processing subsystem, and establishing a connection with the communication object of the first service processing subsystem through the first emergency account.

The step of processing the service of the first service processing subsystem by the second service processing subsystem comprises the following steps performed by the second service processing subsystem: starting using a second emergency account which is preset to be used to connect with a peripheral device of the first service processing subsystem, and establishing a connection with the peripheral device of the first service processing subsystem through the second emergency account.

After the step of processing the service of the first service processing subsystem by the second service processing subsystem, the method further comprises: when a fault of the device in the first service processing subsystem is removed, restoring the mapping relationship by the network device; disconnecting a connection with a communication object and a peripheral device of the first service processing subsystem by the second service processing subsystem; and establishing a connection with the communication object and the peripheral device by the first service processing subsystem.

The step of modifying the mapping relationship of the IP address which is mapped to the first service processing subsystem by the network device responsible for the address mapping comprises: running, by the second service processing subsystem, a preset network device script to control the network device responsible for the address mapping to modify the mapping relationship of the IP address which is mapped to the first service processing subsystem or restore the mapping relationship of the IP address of the first service processing system.

A system for emergency switching comprises a first service processing subsystem, a second service processing subsystem and a network device responsible for address mapping, wherein the network device responsible for the address mapping is used for, after a problem occurs in a device of the first service processing subsystem, modifying a mapping relationship of an Internet Protocol (IP) address which is mapped to the first service processing subsystem so as to map the IP address which is mapped to the first service processing subsystem to the second service processing subsystem; and the second service processing subsystem is used for, after the network device modifies the mapping relationship of the IP address which is mapped to the first service processing subsystem, processing a service of the first service processing subsystem according to data which is stored in advance and needed for processing the service of the first service processing subsystem.

The second service processing subsystem is used for, after the mapping relationship of the IP address which is mapped to the first service processing subsystem is modified by the network device, starting using a first emergency account which is preset to be used to connect with a communication object of the first service processing subsystem and establishing a connection with the communication object of the first service processing subsystem through the first emergency account.

The second service processing subsystem is used for, after the mapping relationship of the IP address which is mapped to the first service processing subsystem is modified by the network device, starting using a second emergency account which is preset to be used to connect with a peripheral device of the first service processing subsystem and establishing a connection with the peripheral device of the first service processing subsystem through the second emergency account.

The network device is further used for, after a fault of the device in the first service processing subsystem is removed, restoring the mapping relationship of the IP address of the first service processing subsystem; the second service processing subsystem is further used for, after the fault of the device in the first service processing subsystem is removed, disconnecting a connection with a communication object and a peripheral device of the first service processing subsystem; and the first service processing subsystem is used for re-establishing a connection with the communication object and the peripheral device after the fault is removed.

The second service processing subsystem is further used for running a network device script preset in the second service processing subsystem to control the network device responsible for the address mapping to modify the mapping relationship of the IP address which is mapped to the first service processing subsystem or restore the mapping relationship of the IP address of the first service processing system.

The embodiment of the present invention provides a method and a system for emergency switching. By configuring a mapped IP address in a previous level network device which can map addresses, the embodiments of the present invention enable corresponding devices in respective service processing subsystems to be backup devices to each other. When a problem occurs in a device of a service processing subsystem, as long as an IP address, which is mapped to the network device, in the previous level network device is mapped to a corresponding device of another service processing subsystem, and the corresponding device in another service processing subsystem acts as a backup device to process a service of the device in which the problem occurs, thus enabling simple and fast starting of a backup device when a problem occurs in the original device.

### BRIEF DESCRIPTION OF THE DRAWINGS

FIG. 1 shows a first flowchart of a method for emergency switching in accordance with an embodiment of the present invention;

FIG. 2 shows a second flowchart of a method for emergency switching in accordance with an embodiment of the present invention;

FIG. 3 shows a structural diagram of a system for emergency switching in accordance with an embodiment of the present invention; and

FIG. 4 shows a structural diagram of a system for emergency switching of multimedia message service in a China Unicom network in accordance with an embodiment of the present invention.

### DETAILED DESCRIPTION OF THE EMBODIMENTS

Embodiments of the present invention provide a method and a system for emergency switching. A network element which is used for address mapping exists in a general system, and the network element may be a router, and in most cases, may be a firewall which is used for security management and address mapping. In accordance with the embodiments of the present invention, by making use of the network element which is able to perform address mapping, the address mapping relationship can be modified after a problem occurs in a device of one service processing subsystem through a beforehand configuration, data which should be forwarded to a service processing subsystem in which a problem occurs are forwarded to another service processing subsystem which acts as a backup service processing subsystem, and the backup service processing subsystem temporarily processes the service of the service processing subsystem in which a problem occurs. Therefore, the backup device can be conveniently and quickly started, meanwhile, as the distance between two service processing subsystems is not limited, high flexibility can be obtained.

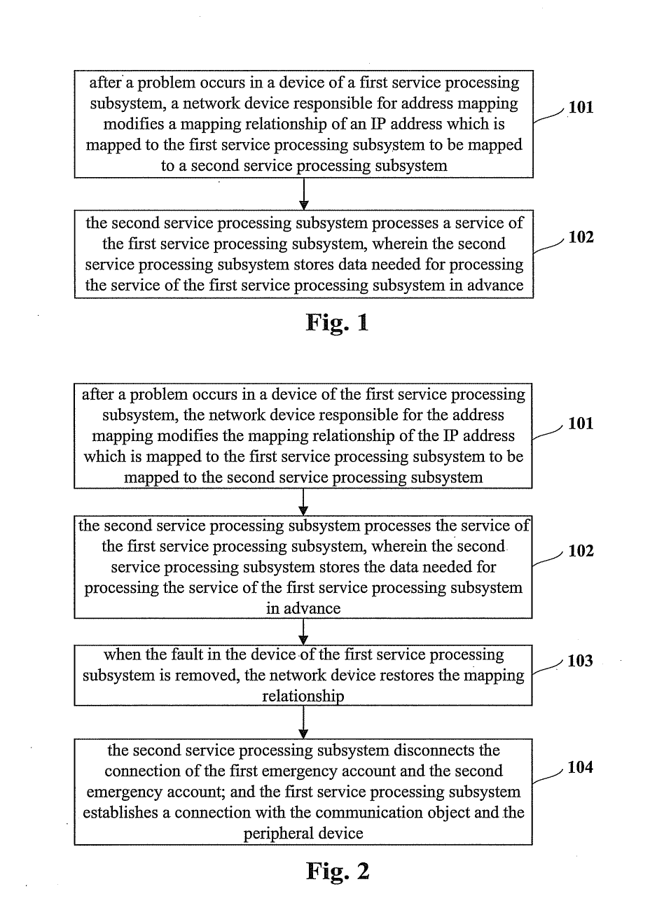

As shown in the FIG. 1, the method for emergency switching provided by an embodiment of the present invention comprises the following steps:

step 101, after a problem occurs in a device of a first service processing subsystem, a network device responsible for address mapping in a communication system modifies a mapping relationship of an IP address which is mapped to the first service processing subsystem so as to map the IP address which is mapped to the first service processing subsystem to a second service processing subsystem; and

step 102, the second service processing subsystem processes a service of the first service processing subsystem, wherein the second service processing subsystem stores data needed for processing the service of the first service processing subsystem in advance.

Thus, as long as the IP address which is mapped to the first service processing subsystem is directly modified to be mapped to the second service processing subsystem according to beforehand configuration, and the data needed for processing the service of the first service processing subsystem are stored in the second service processing subsystem in advance, the second service processing subsystem can act as a backup service processing subsystem of the first service processing subsystem to process the service of the first service processing subsystem temporarily when the first service processing subsystem cannot work normally, therefore the switching process is fast and convenient. As the method of modifying the address mapping relationship is adopted, there is no requirement on the position relationship between the first service processing subsystem and the second service processing subsystem, the first service processing subsystem and the second service processing subsystem can even be located in two cities far away from each other. Consequently, although accidents, such as regional power failure, occur, the method for emergency switching provided by the embodiment of the present invention can be still adopted for emergency treatment.

The network device which is used for address mapping may be a router, a switch or a firewall for security management and address mapping.

Generally spealcing, in order to guarantee the security of a communication procedure, each service processing subsystem is required to establish a connection with a communication object and a peripheral device through an account and realize the processing for communication and relevant service on the basis of the connection. In this case, an emergency account is required to be configured in the second service processing subsystem, specifically, the number of the configured emergency accounts is as many as the number of the communication objects and the peripheral devices with which the connection needs to be established. The second service processing subsystem starts using the first emergency account which is preset to be used to connect with a communication object of the first service processing subsystem and establishes a connection with the communication object of the first service processing subsystem through the first emergency account after the network device modifies the mapping relationship of the IP address which is mapped to the first service processing subsystem. If the first service processing subsystem has a peripheral device, the second service processing subsystem also needs to start a second emergency account which is preset to be used to connect with the peripheral device of the first service processing subsystem and establish a connection with the peripheral device of the first service processing subsystem through the second emergency account.

In addition, according to an embodiment of the present invention, a corresponding network device script is configured on each service processing subsystem. When a service processing subsystem is required to take over the service of another service processing subsystem, the service processing subsystem runs the corresponding network device script to control the network device for address mapping to modify the address mapping relationship and enable the network device to forward data, which are forwarded to the service processing subsystem in which a fault occurs, to the service processing subsystem. When the fault is removed, the service processing subsystem runs a corresponding script to control the network device for address mapping to restore the address mapping relationship and enable the network device to forward the data to the service processing subsystem in which the fault is removed as normal. The modification and restoration of the mapped address are very convenient.

Furthermore, as shown in the FIG. 2, the method for emergency switching in accordance with an embodiment of the present invention further comprises the follows:

step 103, when the fault in the device of the first service processing subsystem is removed, the network device restores the mapping relationship; and

step 104, the second service processing subsystem disconnects the connection of the first emergency account and of the second emergency account; and the first service processing subsystem establishes a connection with the communication object and the peripheral device.

Thus, it is convenient and rapid to disconnect the connection between the second service processing subsystem and the communication object as well as the peripheral device of the first service processing subsystem, so that the switching from the second service processing subsystem to the first service processing subsystem can be realized.

The embodiment of the present invention also provides a system for emergency switching, as shown in the FIG. 3, comprising: a first service processing subsystem 301, a second service processing subsystem 302 and a network device 303 for address mapping, wherein

the network device 303 for the address mapping is used for, after a problem occurs in a device of the first service processing subsystem 301, modifying a mapping relationship of an IP address which is mapped to the first service processing subsystem 301 and enabling the IP address which is mapped to the first service processing subsystem 301 to be mapped to the second service processing subsystem 302; and

the second service processing subsystem 302 is used for, after the network device modifies the mapping relationship of the IP address which is mapped to the first service processing subsystem 301, processing a service of the first service processing subsystem 301 according to data which are stored in advance and needed for processing the service of the first service processing subsystem 301.

The network device 303 may be a router, a switch or a firewall.

Furthermore, when it is required to establish a connection with a communication object of the first service processing subsystem by using an account, the second service processing subsystem 302 is specifically used for, after the network device modifies the mapping relationship of the IP address which is mapped to the first service processing subsystem 301, starting using a first emergency account which is preset to be used to connect with the communication object of the first service processing subsystem 301 and establishing a connection with the communication object of the first service processing subsystem 301 through the first emergency account.

When the first service processing subsystem 301 has a peripheral device, in order to realize secure communication with the peripheral device, the second service processing subsystem 302 is specifically used for, after the network device modifies the mapping relationship of the IP address which is mapped to the first service processing subsystem 301, starting using a second emergency account which is preset to be used to connect with a peripheral device and establishing a connection with the peripheral device of the first service processing subsystem 301 through the second emergency account.

Furthermore, in order to bring convenience to restore an original state after the fault of the first service processing subsystem is removed, the network device 303 is further used for, when the fault in the device of the first service processing subsystem 301 is removed, restoring the mapping relationship of the IP address of the first service processing subsystem 301;

the second service processing subsystem 302 is further used for, when the fault in the device of the first service processing subsystem is removed, disconnecting the connection of the first emergency account and of the second emergency account, that is to say, disconnecting the connection with the communication object as well as the peripheral device of the first service processing subsystem;

the first service processing subsystem 301 is used for re-establishing a connection with the communication object as well as the peripheral device after the fault is removed.

An embodiment is taken for illustration below.

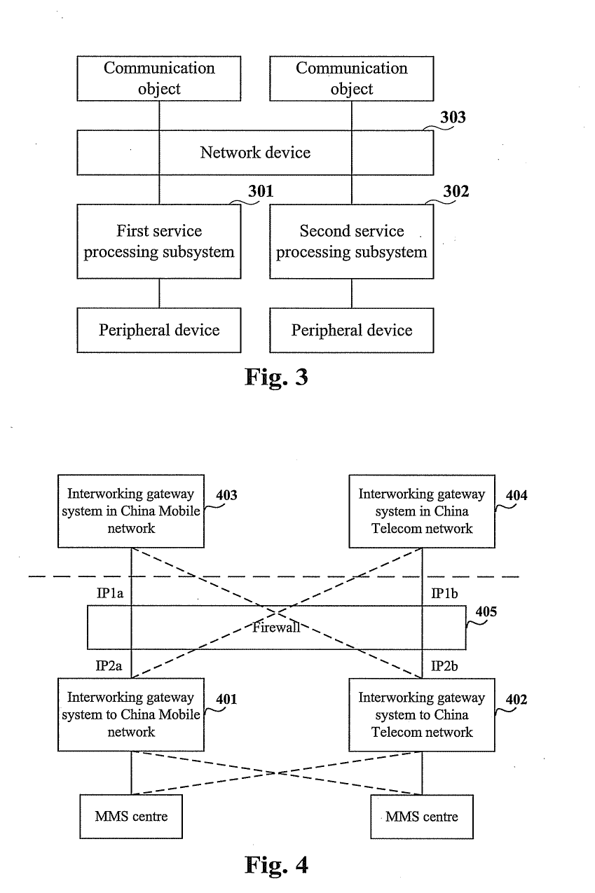

As shown in the FIG. 4, by taking a China Unicom network as an example, the communication technology adopted in the China Unicom network is different from that adopted in a China Mobile network and a China Telecom network, so in order to realize a internetwork service, it is required to set, in the China Unicom network, an interworking gateway system 401 to the China Mobile network and an interworking gateway system 402 to the China Telecom network. Generally, taking the multimedia message service as an example, the interworking gateway system 401 to the China Mobile network and the interworking gateway system 402 to the China Telecom network process respective multimedia messages, and there is no message interaction therebetween.

Providing that the IP address of the interworking gateway system 401 to the China Mobile network is IP2a, the interworking gateway system 401 to the China Mobile network establishes a connection with an interworking gateway system 403 in the China Mobile network through a firewall 405, and the firewall 405 sets the IP address for the connection as IP1a. When the interworking gateway system 403 in the China Mobile network communicates with the interworking gateway system 401 to the China Mobile network, the interworking gateway system 403 in the China Mobile network sends data to the address IP1a, and the firewall 405 maps the address IP1a to the IP2a. Actually, although the interworking gateway system 403 in the China Mobile network sends the data to the address IP1a, the interworking gateway system 403 in the China Mobile network actually sends the data to the interworking gateway system 401 to the China Mobile network with the IP address of IP2a due to the mapping of the firewall 405. For the same reason, providing that the IP address of the interworking gateway system 402 to the China Telecom network is IP2b, the interworking gateway system 402 to the China Telecom network establishes a connection with an interworking gateway system 404 in the China Telecom network through the firewall 405, and the firewall 405 sets the IP address for the connection as IP1b. When the interworking gateway system 404 in the China Telecom network communicates with the interworking gateway system 402 to the China Telecom network, although the interworking gateway system 404 in the China Telecom network sends data to the address IP1b, the interworking gateway system 404 in the China Telecom network actually sends the data to the interworking gateway system 402 to the China Telecom network with the IP address of IP2b due to the mapping of the firewall 405.

In accordance with the method for emergency switching provided by the embodiment of the present invention, after the interworking gateway system 402 to the China Telecom network works abnormally and thus cannot provide a service, preset firewall script or menu operation can be performed on the interworking gateway system 401 to the China Mobile network, and the interworking gateway system 401 to the China Mobile network takes over the service of the interworking gateway system 402 to the China Telecom network. After the preset firewall script or the menu operation is performed on the interworking gateway system 401 to the China Mobile network, the firewall 405 is controlled to modify the address mapped with the IP1b from the IP2b to the IP2a. A message sent from the interworking gateway system 404 in the China Telecom network to the interworking gateway system 402 to the China Telecom network can be directly sent to the interworking gateway system 401 to the China Mobile network according to the address mapping relationship, and such switching costs little time and reduces the service lost to the maximum extent. After the interworking gateway system 402 to the China Telecom network returns to normal, a restoration can be performed in the interworking gateway system 401 to the China Mobile network. After a preset firewall script or menu operation is performed, the firewall 405 is made to restore the address mapped with the IP1b to the IP2b so as to switch the service back to the interworking gateway system 402 to the China Telecom network. For the same reason, when the interworking gateway system 401 to the China Mobile network works abnormally and cannot provide a service, the interworking gateway system 402 to the China Telecom network can act as a backup service processing subsystem.

Furthermore, the emergency switching can be performed in a way of primary and standby transmission links on a network layer, and each link uses a uniform bandwidth.

It is required to configure, in the interworking gateway system 401 to the China Mobile network, account data of the interworking gateway system 402 to the China Telecom network, such as account, password and the like between the interworking gateway system 402 to the China Telecom network and the peripheral device as well as communication object such as the interworking gateway system 404 in the China Telecom network and the MMS centre, and the account is the emergency account. In addition, it is required to configure service data of the interworking gateway system 402 to the China Telecom network, such as network number, number section and the like, so as to guarantee that the interworking gateway system 401 to the China Mobile network can normally process the service, such as authentication, after the takeover. Meanwhile, it is also required to configure the account data and service data of the interworking gateway system 401 to the China Mobile network in the interworking gateway system 402 to the China Telecom network.

One-key takeover and one-key restoration function button or option is added in an operating system, and the firewall script which is required to be used for the takeover or restoration is called directly after the trigger so as to bring convenience to an operator.

For example, the interworking gateway system 401 to the China Mobile network is configured with an account, which is a first emergency account, between the interworking gateway system 402 to the China Telecom network and the interworking gateway system 404 in the China Telecom network; and the interworking gateway system 401 to the China Mobile network is configured with another account, which is a second emergency account, between the interworking gateway system 402 to the China Telecom network and an MMS centre. For the same reason, the interworking gateway system 402 to the China Telecom network is also configured with an account, which is a first emergency account, between the interworking gateway system 401 to the China Mobile network and the interworking gateway system 403 in the China Mobile network; and the interworking gateway system 402 to the China Telecom network is also configured with an account, which is a second emergency account, between the interworking gateway system 401 to the China Mobile network and the MMS centre,

Two following firewall scripts are configured in a configuration interface on the interworking gateway system 401 to the China Mobile network: one script is a firewall script for taking over the Telecom service, i.e. mapping the IP1b to the IP2a; and the other script is a firewall script for restoring the Telecom service to the original interworking gateway system 402 to the China Telecom network, i.e. mapping the IP1b to the IP2b. For the same reason, two following firewall scripts, one of which takes over the Mobile service and the other of which restores the Mobile service, are configured in the configuration interface of the interworking gateway system 402 to the China Telecom network, according to different practical condition, the configured firewall scripts are different, but still realize the takeover and restoration of the service through the mapping relationship of the address. Of course, the firewall in the solution also can be a router or a four-layer switch, as long as they are able to modify the mapping of the IP address.

When a device in the interworking gateway system 402 to the China Telecom network goes wrong, corresponding operation can be performed in the interworking gateway system 401 to the China Mobile network. After the interworking gateway system 401 to the China Mobile network receives a takeover command, or when the interworking gateway system 401 to the China Mobile network funds that the device in the interworking gateway system 402 to the China Telecom network goes wrong based on a handshake protocol, the firewall script for taking over the Telecom service is executed automatically so that the firewall 405 maps the IP1b to the IP2a, when the interworking gateway system 404 in the China Telecom network is accessed from the IP2a, what the opposite end sees is also the IP1b. Thus, the opposite end can be ensured to see the same IP address before and after the switching, and the cooperation of the communication object is unnecessary for the switching. The interworking gateway system 401 to the China Mobile network automatically starts using all the emergency accounts including the emergency account with the interworking gateway system 404 in the China Telecom network and the emergency account to the peripheral device, such as the MMS centre. As the interworking gateway system 401 to the China Mobile network automatically inherits the original account and routing data, the message sent from the MMS centre to a Telecom user is automatically sent to the interworking gateway system 401 to the China Mobile network, and the message sent from the interworking gateway system 404 in the China Telecom network to the Unicom network is also automatically sent to the interworking gateway system 401 to the China Mobile network to finish the takeover of the Telecom service.

When the interworking gateway system 402 to the China Telecom network returns to normal, the restoration operation is performed on the interworking gateway system 401 to the China Mobile network. After receiving a restoration command, the interworking gateway system 401 to the China Mobile network automatically performs the firewall script of restoring the Telecom service so that the firewall 405 maps the IP1b to the IP2b. All the emergency accounts are automatically forbidden, including the accounts with the MMS centre and with the interworking gateway system 404 in the China Telecom network. The connections of the emergency accounts are automatically disconnected. After the start of the interworking gateway system 402 to the China Telecom network, the connections of relevant accounts are established automatically, and the Telecom service is succeeded in restoration.

In accordance with the method and system for emergency switching provided by the embodiments of the present invention, by configuring a mapped IP address in a previous level network device which can map addresses, the embodiments of the present invention enable corresponding devices in respective service processing subsystems to be backup devices to each other. When a problem occurs in a device of a service processing subsystem, as long as an IP address, which is mapped to the network device, in the previous level network device is mapped to a corresponding device of another service processing subsystem, and the corresponding device in another service processing subsystem acts as a backup device to process a service of the device in which the problem occurs, thus enabling simple and fast starting of a backup device when a problem occurs in the original device.

Obviously, those skilled in the art can modify and change the present invention without departing from the scope and spirit of the present invention. Thus, if the modifications and variations of the present invention belong to the scope of the claims and equivalent technologies of the present invention, the present invention is intended to include these modifications and variations.

1. A method for emergency switching, comprising:
after a problem occurs in a device of a first service processing subsystem, modifying, by a network device responsible for address mapping, a mapping relationship of an Internet Protocol (IP) address which is mapped to the first service processing subsystem so as to map the IP address which is mapped to the first service processing subsystem to a second service processing subsystem; and
processing a service of the first service processing subsystem by the second service processing subsystem, wherein the second service processing subsystem stores data needed for processing the service of the first service processing subsystem in advance.

2. The method according to claim 1, wherein the step of processing the service of the first service processing subsystem by the second service processing subsystem comprises the following steps performed by the second service processing subsystem: starting using a first emergency account which is preset to be used to connect with a communication object of the first service processing subsystem, and establishing a connection with the communication object of the first service processing subsystem through the first emergency account.

3. The method according to claim 1, wherein the step of processing the service of the first service processing subsystem by the second service processing subsystem comprises the following steps performed by the second service processing subsystem: starting using a second emergency account which is preset to be used to connect with a peripheral device of the first service processing subsystem, and establishing a connection with the peripheral device of the first service processing subsystem through the second emergency account.

4. The method according to claim 1, wherein after the step of processing the service of the first service processing subsystem by the second service processing subsystem, the method further comprises:
when a fault of the device in the first service processing subsystem is removed, restoring the mapping relationship by the network device;
disconnecting a connection with a communication object and a peripheral device of the first service processing subsystem by the second service processing subsystem;
and establishing a connection with the communication object and the peripheral device by the first service processing subsystem.

5. The method according to claim 4, wherein the step of modifying the mapping relationship of the IP address which is mapped to the first service processing subsystem by the network device responsible for the address mapping comprises: running, by the second service processing subsystem, a preset network device script to control the network device responsible for the address mapping to modify the mapping relationship of the IP address which is mapped to the first service processing subsystem or restore the mapping relationship of the IP address of the first service processing system.

6. A system for emergency switching, comprising a first service processing subsystem, a second service processing subsystem and a network device responsible for address mapping, wherein
the network device responsible for the address mapping is used for, after a problem occurs in a device of the first service processing subsystem, modifying a mapping relationship of an Internet Protocol (IP) address which is mapped to the first service processing subsystem so as to map the IP address which is mapped to the first service processing subsystem to the second service processing subsystem; and
the second service processing subsystem is used for, after the network device modifies the mapping relationship of the IP address which is mapped to the first service processing subsystem, processing a service of the first service processing subsystem according to data which is stored in advance and needed for processing the service of the first service processing subsystem.

7. The system according to claim 6, wherein the second service processing subsystem is used for, after the mapping relationship of the IP address which is mapped to the first service processing subsystem is modified by the network device, starting using a first emergency account which is preset to be used to connect with a communication object of the first service processing subsystem and establishing a connection with the communication object of the first service processing subsystem through the first emergency account.

8. The system according to claim 6, wherein the second service processing subsystem is used for, after the mapping relationship of the IP address which is mapped to the first service processing subsystem is modified by the network device, starting using a second emergency account which is preset to be used to connect with a peripheral device of the first service processing subsystem and establishing a connection with the peripheral device of the first service processing subsystem through the second emergency account.

9. The system according to claim 6, wherein the network device is further used for, after a fault of the device in the first service processing subsystem is removed, restoring the mapping relationship of the IP address of the first service processing subsystem;
the second service processing subsystem is further used for, after the fault of the device in the first service processing subsystem is removed, disconnecting a connection with a communication object and a peripheral device of the first service processing subsystem; and
the first service processing subsystem is used for re-establishing a connection with the communication object and the peripheral device after the fault is removed.

10. The system according to claim 9, wherein the second service processing subsystem is further used for running a network device script preset in the second service processing subsystem to control the network device responsible for the address mapping to modify the mapping relationship of the IP address which is mapped to the first service processing subsystem or restore the mapping relationship of the IP address of the first service processing system.

11. The method according to claim 2, wherein after the step of processing the service of the first service processing subsystem by the second service processing subsystem, the method further comprises:
when a fault of the device in the first service processing subsystem is removed, restoring the mapping relationship by the network device;
disconnecting a connection with a communication object and a peripheral device of the first service processing subsystem by the second service processing subsystem; and establishing a connection with the communication object and the peripheral device by the first service processing subsystem.

12. The method according to claim 3, wherein after the step of processing the service of the first service processing subsystem by the second service processing subsystem, the method further comprises:
when a fault of the device in the first service processing subsystem is removed, restoring the mapping relationship by the network device;
disconnecting a connection with a communication object and a peripheral device of the first service processing subsystem by the second service processing subsystem; and establishing a connection with the communication object and the peripheral device by the first service processing subsystem.

13. The method according to claim 11, wherein the step of modifying the mapping relationship of the IP address which is mapped to the first service processing subsystem by the network device responsible for the address mapping comprises: running, by the second service processing subsystem, a preset network device script to control the network device responsible for the address mapping to modify the mapping relationship of the IP address which is mapped to the first service processing subsystem or restore the mapping relationship of the IP address of the first service processing system.

14. The method according to claim 12, wherein the step of modifying the mapping relationship of the IP address which is mapped to the first service processing subsystem by the network device responsible for the address mapping comprises: running, by the second service processing subsystem, a preset network device script to control the network device responsible for the address mapping to modify the mapping relationship of the IP address which is mapped to the first service processing subsystem or restore the mapping relationship of the IP address of the first service processing system.

15. The system according to claim 7, wherein
the network device is further used for, after a fault of the device in the first service processing subsystem is removed, restoring the mapping relationship of the IP address of the first service processing subsystem;
the second service processing subsystem is further used for, after the fault of the device in the first service processing subsystem is removed, disconnecting a connection with a communication object and a peripheral device of the first service processing subsystem; and
the first service processing subsystem is used for re-establishing a connection with the communication object and the peripheral device after the fault is removed.

16. The system according to claim 8, wherein
the network device is further used for, after a fault of the device in the first service processing subsystem is removed, restoring the mapping relationship of the IP address of the first service processing subsystem;
the second service processing subsystem is further used for, after the fault of the device in the first service processing subsystem is removed, disconnecting a connection with a communication object and a peripheral device of the first service processing subsystem; and
the first service processing subsystem is used for re-establishing a connection with the communication object and the peripheral device after the fault is removed.

17. The system according to claim 15, wherein the second service processing subsystem is further used for running a network device script preset in the second service processing subsystem to control the network device responsible for the address mapping to modify the mapping relationship of the IP address which is mapped to the first service processing subsystem or restore the mapping relationship of the IP address of the first service processing system.

18. The system according to claim 16, wherein the second service processing subsystem is further used for running a network device script preset in the second service processing subsystem to control the network device responsible for the address mapping to modify the mapping relationship of the IP address which is mapped to the first service processing subsystem or restore the mapping relationship of the IP address of the first service processing system.
